(19) United States
(12) Patent Application Publication
(10) Pub. No.: US 2025/0074183 A1
(43) Pub. Date: Mar. 6, 2025

(54) GO-KART

(71) Applicant: Greenworks (Jiangsu) Co., Ltd., Changzhou (CN)

(72) Inventor: Jin Huang, Changzhou (CN)

(21) Appl. No.: 18/815,837

(22) Filed: Aug. 27, 2024

(30) Foreign Application Priority Data
Aug. 30, 2023 (CN) 202322356739.3

(51) Int. Cl. B60K 7/00; B60K 1/04; B60T 1/06; B60T 7/04; B62D 21/11

(52) U.S. Cl. CPC B60K 7/0007; B60K 1/04; B60T 1/065; B60T 7/04; B62D 21/11

(57) ABSTRACT

A go-kart includes a frame assembly and a wheel assembly. The wheel assembly is mounted on the frame assembly. The wheel assembly includes a walking wheel and a hub motor connected with the walking wheel, the hub motor is provided with a motor shaft, and the frame assembly is correspondingly provided with a frame sleeve. A first end of the motor shaft is connected with the hub motor, and a second end of the motor shaft passes through the frame sleeve and is fixedly connected with the frame sleeve.

### CROSS REFERENCE TO RELATED APPLICATION

The present application claims the priority of the following Chinese patent application: serial No. 202322356739.3, filed on Aug. 30, 2023; the disclosure of which is hereby incorporated by reference herein in its entirety for all purposes.

### TECHNICAL FIELD

The disclosure relates to a technical field of vehicles, in particular to a go-kart.

### BACKGROUND

At present, most go-karts on the market are powered by gasoline engines or ordinary mid-mounted motors. However, gasoline engines have disadvantages such as high noise, low efficiency, environmental pollution, and large space occupation. Mid-mounted motors need to be used in conjunction with structures such as speed gear boxes, which not only occupy a large space but also have a complex structure.

In view of this, it is necessary to improve the conventional structure of the go-karts to solve the problems mentioned above.

### SUMMARY

The disclosure provides a go-kart with a hub motor and a simple structure.

The disclosure provides the go-kart, and the go-kart includes a frame assembly and a wheel assembly.

The wheel assembly is mounted on the frame assembly.

The wheel assembly includes a walking wheel and a hub motor connected with the walking wheel, the hub motor is provided with a motor shaft, the frame assembly is provided with a frame sleeve, a first end of the motor shaft is connected with the hub motor, and a second end of the motor shaft passes through the frame sleeve and is connected with the frame sleeve.

In an embodiment of the disclosure, a first matching part is arranged at the second end of the motor shaft away from the walking wheel, a second matching part is arranged inside the frame sleeve, and when the motor shaft is connected with the frame sleeve, the first matching part and the second matching part are matched with each other to connect the motor shaft to the frame sleeve.

In an embodiment of the disclosure, the go-kart according to claim 2, wherein, the first matching part is an external spline, the second matching part is an internal spline, and the external spline and the internal spline are meshed with each other to connect the first matching part with the second matching part.

In an embodiment of the disclosure, an outer wall of the motor shaft adjacent to the walking wheel is configured as a smooth surface.

In an embodiment of the disclosure, a first step part is arranged on the motor shaft, a second step part is arranged inside the frame sleeve, and when the motor shaft is connected with the frame sleeve, the first step part abuts against the second step part to axially limit the motor shaft.

In an embodiment of the disclosure, the second end of the motor shaft passes through the frame sleeve and is fixedly connected with the frame sleeve through a fastener.

In an embodiment of the disclosure, a tail end of the motor shaft is provided with an external thread, the fastener is a nut with an internal thread, and the internal thread of the nut is configured to be meshed with the external thread of the tail end of the motor shaft.

In an embodiment of the disclosure, the go-kart further includes a disc brake assembly, the disc brake assembly includes a disc brake pad, and the disc brake pad is sleeved on the motor shaft and fixedly connected with the hub motor.

In an embodiment of the disclosure, the disc brake assembly further includes a disc brake pump and a caliper, the caliper is mounted on the frame assembly and connected with the disc brake pump, and the caliper is clamped on two sides of the disc brake pad and is controlled by the disc brake pump to clamp the disc brake pad tightly in order to stop the hub motor from rotating.

In an embodiment of the disclosure, the go-kart further includes a foot brake, the foot brake is connected with the disc brake assembly by a brake hose, and the foot brake is configured to control the disc brake assembly to brake the go-kart.

In an embodiment of the disclosure, the go-kart further includes a battery assembly, the battery assembly is mounted on the frame assembly and is electrically connected with the hub motor, and the battery assembly is configured to supply power to the hub motor.

In an embodiment of the disclosure, the go-kart further includes a shock absorbing assembly, the frame assembly includes a main frame, a rear frame and a bottom frame, the rear frame and the bottom frame are pivotally connected with the main frame, the wheel assembly and the battery assembly are both mounted on the rear frame, a first end of the shock absorbing assembly is connected with the main frame, and a second end of the shock absorbing assembly is connected with the rear frame or the bottom frame.

In an embodiment of the disclosure, a buffering sleeve is arranged on the rear frame, and the rear frame is pivotally mounted with the main frame through the buffering sleeve.

In an embodiment of the disclosure, the frame assembly further comprises a bracket and a mounting base mounted on the bracket, the bracket extends obliquely upwardly from the bottom frame and is located above the rear frame, and the battery assembly is mounted on the mounting base.

Beneficial effects of one or more embodiments of the disclosure are that the go-kart is provided with the motor shaft on the hub motor and at the same time a frame sleeve is correspondingly arranged on the frame assembly, so that when the hub motor and the frame assembly are assembled, it is only necessary to pass the motor shaft through the frame sleeve and fix the motor shaft with the frame sleeve, which has a simple structure, and a faster and more convenient assembly and disassembly process. The hub motor is directly assembled with the frame assembly, which reduces a use of parts. At the same time, it also enables a connection between the hub motor and the frame assembly to be more stable and less likely to loosen, thereby reducing a failure rate and extending a duration life of the go-kart.

### BRIEF DESCRIPTION OF THE DRAWINGS

FIG. 1 is a perspective structural view of a go-kart according to at least one embodiment of the disclosure.

FIG. 2 is an exploded view of FIG. 1.

FIG. 3 is a perspective structural view of a hub motor in FIG. 2.

FIG. 4 is a partial structural view of the hub motor in FIG. 3.

FIG. 5 is a perspective structural view of a rear frame in FIG. 1.

FIG. 6 is a perspective structural view of a frame sleeve in FIG. 5.

FIG. 7 is an assembled structural view of the rear frame and the hub motor in FIG. 5.

FIG. 8 is an assembled structural view of a disc brake pump and a caliper in FIG. 2.

### DETAILED DESCRIPTION

In order to enable a purpose, technical solutions and advantages of the disclosure to be clearer, the disclosure will be described in detail below with reference to drawings and specific embodiments.

It should be noted that, in order to avoid obscuring the disclosure with unnecessary details, only structures and/or processing steps closely related to the solution of the disclosure are shown in the drawings, while other details that are not closely related to the disclosure are omitted.

Additionally, it should be noted that a term “comprises”, “includes” or any other variation thereof is intended to cover a non-exclusive inclusion such that a process, method, article or apparatus including a set of elements includes not only those elements, but also other elements not expressly listed, or elements inherent to the process, method, article, or apparatus.

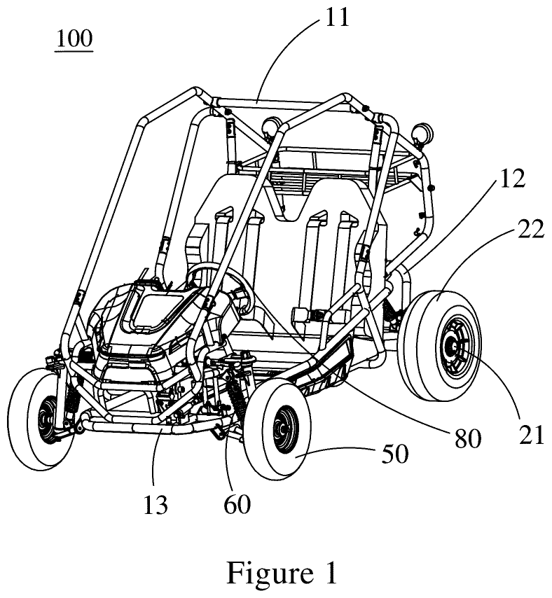

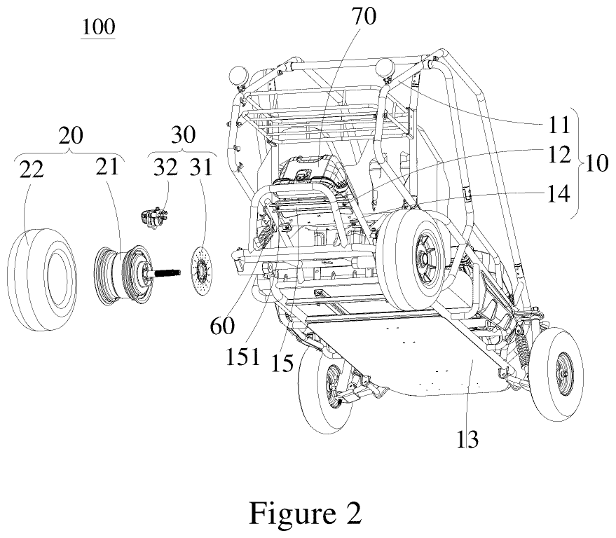

Please refer to FIG. 1 and FIG. 2. An embodiment of the disclosure provides a go-kart 100. The go-kart 100 includes a frame assembly 10 and a wheel assembly 20. The wheel assembly 20 is mounted on the frame assembly 10. The wheel assembly 20 includes a walking wheel 22 and a hub motor 21 connected with the walking wheel 22, the hub motor 21 is provided with a motor shaft 210, and the frame assembly 10 is correspondingly provided with a frame sleeve 121. A first end of the motor shaft 210 is connected with the hub motor 21, and a second end of the motor shaft 320 passes through the frame sleeve 121 and is fixedly connected with the frame sleeve 121 and the frame assembly 10. In this way, the wheel assembly 20 and the frame assembly 10 are assembled and fixed.

With an arrangement of the frame sleeve 121, an assembly and a disassembly process of the hub motor 21 and the frame assembly 10 are faster and more convenient. The hub motor 21 is directly assembled with the frame assembly 10, which reduces a use of parts and has a simpler structure. At the same time, it also enables a connection between the hub motor 21 and the frame assembly 10 to be more stable and less likely to loosen, thereby reducing a failure rate and extending a duration life of the go-kart 100.

In this embodiment, the hub motor 21 is directly embedded in the walking wheel 22, so that a transmission efficiency is more efficient and a structure is simpler. Of course, in other embodiments, the hub motor 21 may also be mounted in the front wheel 50, which is not limited.

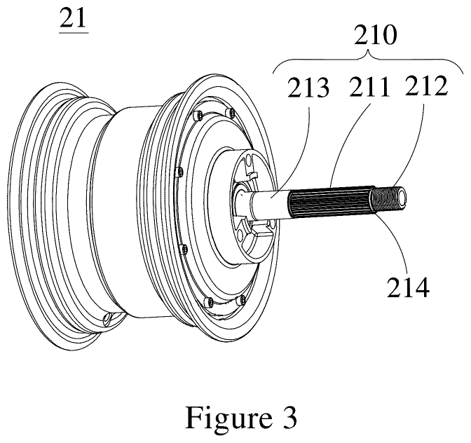

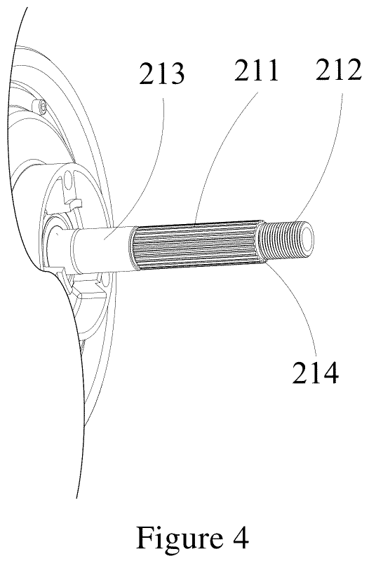

Please refer to FIG. 3, FIG. 4, and FIG. 6. In this embodiment, a first matching part 211 is arranged on an outer side wall of the second end of the motor shaft 210 away from the walking wheel 22, and a second matching part 1211 is correspondingly arranged inside the frame sleeve 121, so that when the motor shaft 210 and the frame sleeve 121 are assembled, the second matching part 1211 and the first matching part 211 may be matched with each other to achieve a stable connection between the motor shaft 210 and the frame sleeve 121. In some embodiments, the first matching part 211 is an external spline, and the second matching part 1211 is an internal spline, so that the external spline and the internal spline may be meshed with each other to achieve a tight connection between the first matching part 211 and the second matching part 1211 and play a better anti-rotation effect. An outer wall surface of the motor shaft 210 near the walking wheel 22 is set as a smooth surface 213. The smooth surface 213 can increase a matching accuracy and strength between the motor shaft 210 and the frame sleeve 121, thereby preventing the motor shaft 210 from rotating relative to the frame sleeve 121 during a rotation of the hub motor 21.

Of course, in other embodiments, the motor shaft 210 may also be set as a polygonal rotating shaft without arranging the external spline. At this time, the frame sleeve 121 is correspondingly set as a polygonal sleeve, and there is no need to set the internal spline. It means that the motor shaft 210 may be tightly connected with the frame sleeve 121 through a mutual matching of the polygonal rotating shaft and the polygonal sleeve, and the anti-rotation effect may be achieved.

A first step part 214 is arranged on the motor shaft 210, and a second step part 1212 is correspondingly arranged in the frame sleeve 121. When the motor shaft 210 is inserted into the frame sleeve 121 and fixedly connected with the frame sleeve 121, the first step part 214 and the second step part 1212 abut against each other, thereby being able to axially limit the motor shaft 210 and prevent the motor shaft 210 from axially moving relative to the frame sleeve 121.

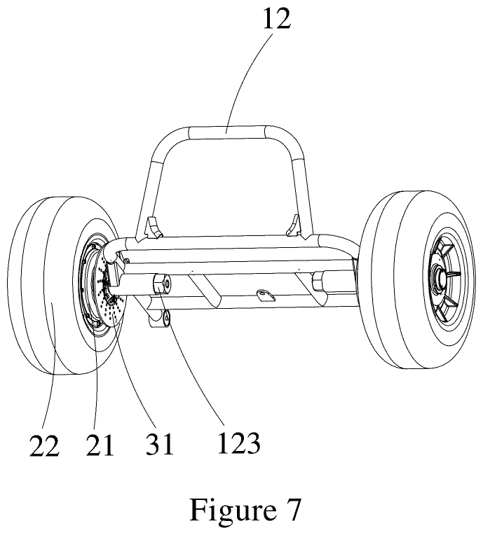

Please refer to FIG. 7. After the motor shaft 210 passes through the frame sleeve 121, in order to further ensure a connection stability between the motor shaft 210 and the frame sleeve 121, an embodiment of the disclosure further provides a fastener 123. When the motor shaft 210 passes through the frame sleeve 121, the second end of the motor shaft 210 passes through the frame sleeve 121. At this time, the fastener 123 may be used to connect with the end of the motor shaft 210 passing through the frame sleeve 121, so that the motor shaft 210 and the frame sleeve 121 are firmly fixed.

In this embodiment, the fastener 123 is a nut with an internal thread, and an outer side wall of a tail end of the motor shaft 210 is correspondingly provided with an external thread 212, so that a connection may be achieved by simply tightening the nut 123 and the tail end of the motor shaft 210. Of course, in other embodiments, the fastener 123 may also be other parts as long as it can be locked and fixed with the motor shaft 210, which is not limited here.

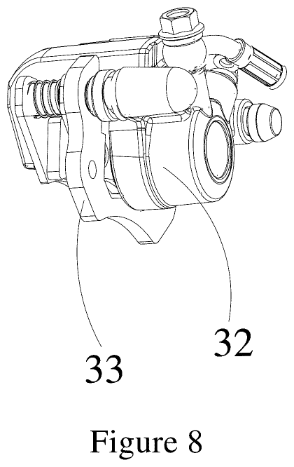

Please refer to FIG. 2 and FIG. 8. The go-kart 100 further includes a disc brake assembly 30 for braking the go-kart 100. The disc brake assembly 30 includes a disc brake pad 31, a disc brake pump 32 and a caliper 33. The disc brake pad 31 is sleeved on the motor shaft 210 and fixedly connected with the hub motor 21. The caliper 33 is mounted on the frame assembly 10 and connected with the disc brake pump 32. In some embodiments, the caliper 33 is clamped on two sides of the disc brake pad 31, so that the caliper 33 may be controlled by the disc brake pump 32 to clamp the disc brake pad 31 tightly to control the hub motor 21 to stop rotating.

In an embodiment, the disc brake pad 31 is fixedly connected with the hub motor 21 directly to rotate synchronously with the hub motor 21. The caliper 33 is directly assembled on the frame assembly 10 and connected with the disc brake pump 32. In this embodiment, the disc brake pump 32 is hydraulically controlled, so when the go-kart 100 is braked, the disc brake pump 32 may control the caliper 33 to clamp the disc brake pad 31 tightly, and then control the hub motor 21 to reduce the rotating speed until it stops. An arrangement of the disc brake assembly 30 enables the go-kart 100 to have a better braking stability. Moreover, since the disc brake pad 31 has no amplifying effect on friction, after a long-term braking and heating, a change in a friction coefficient of the disc brake pad 31 has little effect on its braking performance, and it has good resistance to thermal decay and better safety.

In an embodiment, the go-kart 100 further includes a foot brake (not shown), the foot brake is connected with the disc brake assembly 30 through an brake hose, and the foot brake is configured to control the disc brake assembly 30 to brake the go-kart 100. In other words, a power of the foot brake is transmitted to the disc brake pump 32 through the brake hose, which then controls the disc brake assembly 30 to work and brake the go-kart 100.

Please refer to FIG. 2. The go-kart 100 further includes a battery assembly 70. The battery assembly 70 is electrically connected with the hub motor 21 and is used to supply power to the hub motor 21. In some embodiments, the battery assembly 70 is fixedly mounted on the frame assembly 10 through shock absorbing screws, and is electrically connected with the hub motors 21 on two sides, so as to provide required power for rotation to the hub motors 21.

The go-kart 100 further includes a shock absorbing assembly 60. The frame assembly 10 includes a main frame 11, a rear frame 12 and a bottom frame 13. The rear frame 12 and the bottom frame 13 are pivotally connected with the main frame 11, and the wheel assembly 20 and the battery assembly 70 are both mounted on the rear frame 12. In order to provide a better driving experience, there are four groups of shock absorbing assemblies 60, which includes two groups located at a front end of the go-kart 100 and two groups located at a rear end of the go-kart 100. The two groups of shock absorbing assemblies 60 located at the front end are connected between the main frame 11 and the bottom frame 13, and the two groups of shock absorbing assemblies 60 located at the rear end are connected between the main frame 11 and the rear frame 12.

In this embodiment, the shock absorbing assembly 60 is a spring. A first end of the two groups of the springs at the front end is connected with the main frame 11, and a second end of the two groups of the springs at the front end is connected with the bottom frame 13. A first end of the two groups of the springs at the rear end is connected with the main frame 11, and a second end of the two groups of the springs at the rear end is connected with the rear frame 12. Therefore, during a driving process of the go-kart 100, the shock absorbing assembly 60 may effectively absorb a vibration of the go-kart 100 and reduce an impact force suffered by the main frame 11, so as to protect the frame assembly 10 and extend a duration life of the go-kart 100.

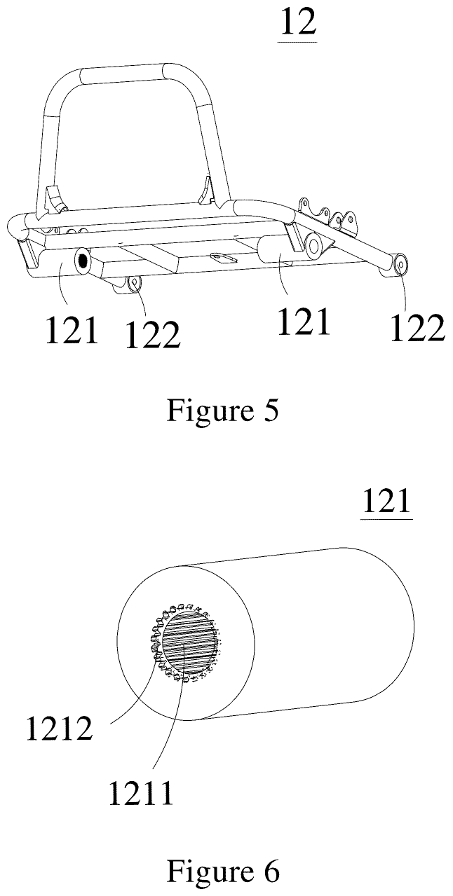

Please refer to FIG. 5. A buffering sleeve 122 is arranged on the rear frame 12, and the rear frame 12 is pivotally mounted with the main frame 11 through the buffering sleeve 122. With such arrangement, the buffering sleeve 122 may be used to better absorb a shock of the battery assembly 70 on the rear frame 12, thereby ensuring a stability of a contact between a battery pack and an electrode in the battery assembly 70, avoiding an occurrence of adverse consequences such as spark erosion and relative wear of contacting components, and improving a safety of the go-kart 100.

The frame assembly 10 further includes a bracket 14 and a mounting base 15. The bracket 14 extends obliquely upwardly from the bottom frame 13 and is located above the rear frame 12. The mounting base 15 is fixedly mounted on the bracket 14 through the shock absorbing screws 151. The battery assembly 70 is fixedly mounted on the mounting base 15. In this embodiment, the shock absorbing screw 151 is a shock absorbing double end screw.

Please refer to FIG. 1. The go-kart 100 further includes a steering wheel 80 and a transmission assembly. The steering wheel 80 is connected with the front wheels 50 through the transmission assembly, so that the steering wheel 80 may be used to control a steering of the front wheels 50. In some embodiments, the front wheels 50 are universe wheels, and a walking direction of the go-kart 100 may be changed by controlling a steering of the front wheels 50.

In summary, the go-kart 100 in one or more embodiments of the disclosure is provided with the motor shaft 210 on the hub motor and at the same time a frame sleeve 121 is correspondingly arranged on the rear frame 12, so that when the hub motor 21 and the frame assembly 10 are assembled, it is only necessary to pass the motor shaft 210 through the frame sleeve 121 and fix the motor shaft 210 with the frame sleeve 121, which has a simple structure, and a faster and more convenient assembly and disassembly process. The hub motor 21 is directly assembled with the frame, which reduces components. At the same time, it also enables a connection between the hub motor 21 and the frame assembly 10 to be more stable and less likely to loosen, thereby reducing a failure rate and extending the duration life of the go-kart 100.

The above embodiments are only used to illustrate the technical solutions of the disclosure and are not limiting. Although the disclosure has been described in detail with reference to the preferred embodiments, those of ordinary skill in the art should understand that the technical solutions of the disclosure may be modified or equivalent substituted without departing from a scope of the technical solution of the disclosure.

What is claimed is:

1. A go-kart, comprising:
a frame assembly; and
a wheel assembly mounted on the frame assembly;
wherein, the wheel assembly comprises a walking wheel and a hub motor connected with the walking wheel, the hub motor is provided with a motor shaft, the frame assembly is provided with a frame sleeve, a first end of the motor shaft is connected with the hub motor, and a second end of the motor shaft passes through the frame sleeve and is connected with the frame sleeve.

2. The go-kart according to claim 1, wherein, a first matching part is arranged at the second end of the motor shaft away from the walking wheel, a second matching part is arranged inside the frame sleeve, and when the motor shaft is connected with the frame sleeve, the first matching part and the second matching part are matched with each other to connect the motor shaft to the frame sleeve.

3. The go-kart according to claim 2, wherein, the first matching part is an external spline, the second matching part is an internal spline, and the external spline and the internal spline are meshed with each other to connect the first matching part with the second matching part.

4. The go-kart according to claim 1, wherein, an outer wall of the motor shaft adjacent to the walking wheel is configured as a smooth surface.

5. The go-kart according to claim 1, wherein, a first step part is arranged on the motor shaft, a second step part is arranged inside the frame sleeve, and when the motor shaft is connected with the frame sleeve, the first step part abuts against the second step part to axially limit the motor shaft.

6. The go-kart according to claim 1, wherein, the second end of the motor shaft passes through the frame sleeve and is fixedly connected with the frame sleeve through a fastener.

7. The go-kart according to claim 6, wherein, a tail end of the motor shaft is provided with an external thread, the fastener is a nut with an internal thread, and the internal thread of the nut is configured to be meshed with the external thread of the tail end of the motor shaft.

8. The go-kart according to claim 1, further comprising a disc brake assembly, wherein, the disc brake assembly comprises a disc brake pad, and the disc brake pad is sleeved on the motor shaft and fixedly connected with the hub motor.

9. The go-kart according to claim 8, wherein, the disc brake assembly further comprises a disc brake pump and a caliper, the caliper is mounted on the frame assembly and connected with the disc brake pump, and the caliper is clamped on two sides of the disc brake pad and is controlled by the disc brake pump to clamp the disc brake pad tightly in order to stop the hub motor from rotating.

10. The go-kart according to claim 8, further comprising a foot brake, wherein, the foot brake is connected with the disc brake assembly by a brake hose, and the foot brake is configured to control the disc brake assembly to brake the go-kart.

11. The go-kart according to claim 1, further comprising a battery assembly, wherein, the battery assembly is mounted on the frame assembly and is electrically connected with the hub motor, and the battery assembly is configured to supply power to the hub motor.

12. The go-kart according to claim 11, further comprising a shock absorbing assembly, wherein, the frame assembly comprises a main frame, a rear frame and a bottom frame, the rear frame and the bottom frame are pivotally connected with the main frame, the wheel assembly and the battery assembly are both mounted on the rear frame, a first end of the shock absorbing assembly is connected with the main frame, and a second end of the shock absorbing assembly is connected with the rear frame or the bottom frame.

13. The go-kart according to claim 12, wherein, a buffering sleeve is arranged on the rear frame, and the rear frame is pivotally mounted with the main frame through the buffering sleeve.

14. The go-kart according to claim 12, wherein, the frame assembly further comprises a bracket and a mounting base mounted on the bracket, the bracket extends obliquely upwardly from the bottom frame and is located above the rear frame, and the battery assembly is mounted on the mounting base.
